(19) United States
(12) Patent Application Publication
(10) Pub. No.: US 2025/0005525 A1
(43) Pub. Date: Jan. 2, 2025

(54) AI CREATIVE WORK CONTRIBUTION SYSTEM

(71) Applicant: Charles Isgar, Scottsdale, AZ (US)

(72) Inventor: Charles Isgar, Scottsdale, AZ (US)

(21) Appl. No.: 18/884,511

(22) Filed: Sep. 13, 2024

Related U.S. Application Data
(63) Continuation-in-part of application No. 18/827,950, filed on Sep. 9, 2024.
Application No. 18/827,950 is a continuation of application No. 17/933,542, filed on Sep. 20, 2022, now Pat. No. 12,086,765.
Application No. 17/933,542 is a continuation of application No. 17/192,064, filed on Mar. 4, 2021, now abandoned.
(60) Provisional application No. 62/985,295, filed on Mar. 4, 2020.
(60) Provisional application No. 62/985,297, filed on Mar. 4, 2020.

(51) Int. Cl. G06Q 10/101; G06F 16/9535; G06Q 10/10; H04L 65/401; H04L 65/4053; H04L 67/306

(52) U.S. Cl. CPC G06Q 10/101; G06F 16/9535; G06Q 10/103; H04L 65/4015; H04L 65/4053; H04L 67/306

(57) ABSTRACT

Described is an AI creative work contribution system. The system includes a server having a memory storing artificial intelligence software and a creator computing device of a creator coupled to the server. The server may be programmed with the artificial intelligence software to receive and store a request for assistance with a creative work from the creator computing device. The server may further be programmed to automatically process and analyze the request for assistance with the creative work and generate a generated content to the request for assistance with the creative work. Once the generated content is generated, the server may be programmed to automatically deliver the generated content for display on the creator computing device.

### CROSS REFERENCE TO RELATED APPLICATION

This application is a continuation-in-part of U.S. patent application Ser. No. 18/827,950, filed Sep. 9, 2024, which is a continuation of U.S. patent application Ser. No. 17/933,542, filed Sep. 20, 2022, which is a continuation of U.S. patent application Ser. No. 17/192,064, filed on Mar. 4, 2021, which claims priority to U.S. Provisional Patent Applications Ser. No. 62/985,295, filed Mar. 4, 2020, and Ser. No. 62/985,297, filed Mar. 4, 2020, the disclosures of which are hereby incorporated entirely herein by reference.

### BACKGROUND OF THE INVENTION

### Technical Field

This invention generally relates to a system for contributing to a creative work, and more specifically to an artificial intelligence creative work contribution system for generating and providing artificial intelligence created content at a request from the creator.

### State of the Art

Many creative individuals, groups and work teams often engage a mental obstacle when developing a creative work. Other times, these individuals often do not know how to complete the creative work, such as when creating computer code. This can stymie a creator's ability to complete a work. Conventionally, there is no solution for overcoming these mental obstacles in order to complete the work. Typically, it just takes time.

Accordingly, what is needed is an AI creative work contribution system for utilizing data/analysis related to a creative work to incorporate AI work product in the creative process.

### SUMMARY OF THE INVENTION

An embodiment includes an AI creative work contribution system comprising: a server having a memory storing artificial intelligence software; and a creator computing device of a creator coupled to the server, wherein the server is programmed with the artificial intelligence software to: receive and store a request for assistance with a creative work from the creator computing device; automatically process and analyze the request for assistance with the creative work; generate a generated content to the request for assistance with the creative work; and automatically deliver the generated content for display on the creator computing device.

Another embodiment includes an AI creative work contribution system comprising: a server having a memory storing artificial intelligence software; and a creator computing device of a creator coupled to the server, wherein the server is programmed with the artificial intelligence software to: receive and store a request for assistance with a computer code from the creator computing device; automatically process and analyze the request for assistance with the computer code; generate a suggested computer code to the request for assistance with the computer code; and automatically deliver the suggested computer code for display on the creator computing device.

The foregoing and other features and advantages of the invention will be apparent to those of ordinary skill in the art from the following more particular description of the invention and the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 a diagrammatic view of an AI creative work contribution system according to an embodiment;

FIG. 2 depicts a creator computing device operating an AI creative work contribution system to request contributions from an AI creative work contribution system according to an embodiment;

FIG. 3A depicts a creator computing device operating as part of an AI creative work contribution system to contribute computer code according to an embodiment;

FIG. 3B depicts the creator computing device operating as part of an AI creative work contribution system depicting AI contributions to the computer code in FIG. 3A according to an embodiment;

FIG. 4A depicts a creator computing device operating as part of an AI creative work contribution system to contribute written content according to an embodiment;

FIG. 4B depicts the creator computing device operating as part of an AI creative work contribution system depicting AI contributions to the written content in FIG. 4A according to an embodiment;

FIG. 5A depicts a creator computing device operating as part of an AI creative work contribution system to contribute music content according to an embodiment;

FIG. 5B depicts the creator computing device operating as part of an AI creative work contribution system depicting AI contributions to the music content in FIG. 5A according to an embodiment;

FIG. 6 is a method of operation an AI creative work contribution system according to an embodiment; and

FIG. 7 is a method of developing a model for generating creative content by an AI creative work contribution system according to an embodiment.

### DETAILED DESCRIPTION OF EMBODIMENTS OF THE INVENTION

Embodiments of the present invention relate to an artificial intelligence (“AI”) creative work contribution system for AI input on a creative work at a request from the creator in order to overcome a mental obstacle or lack of knowledge in the creative process. The system may include the use of a creator computing device, such as any type of computing device operating a downloadable application or a web application; and/or the creator computing device may be a mobile computing device like a smartphone, a tablet, a wearable, and the like operating mobile application.

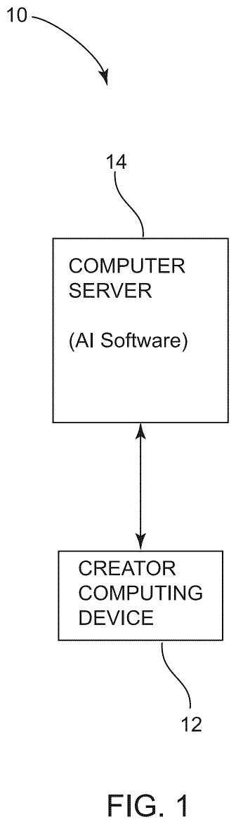

FIG. 1 depicts an embodiment of a creative work contribution system 10. The system 10 may include a creator computing device 12 and a server 14, wherein the creator computing device 12 are coupled to the computer server 14. This coupling may be a network connection, such as a wireless connection through an Internet connection, a wireless connection, a Wi-Fi connection, a Bluetooth connection or the like, wherein the creator computing device 12 may communicate with and receive communication from the server 14. The creator computing device 12 may include a desktop computer, a laptop, a tablet, a smartphone, wearable devices and the like. The server 14, in some embodiments, may be a computer server or a cloud-based infrastructure architecture.

The server 14 may include a memory storing various data. The memory of the server 14 may store user information, such as demographic information, and may further store creative work requests and contributions given and received relating to each creative work request and the demographic information of the contributor(s). The server 14 may also comprise AI software that is programmed to operate as part of the system 10, wherein the AI software operates to generate and transmit AI generated creative content in response to a request from the creator computing device 12.

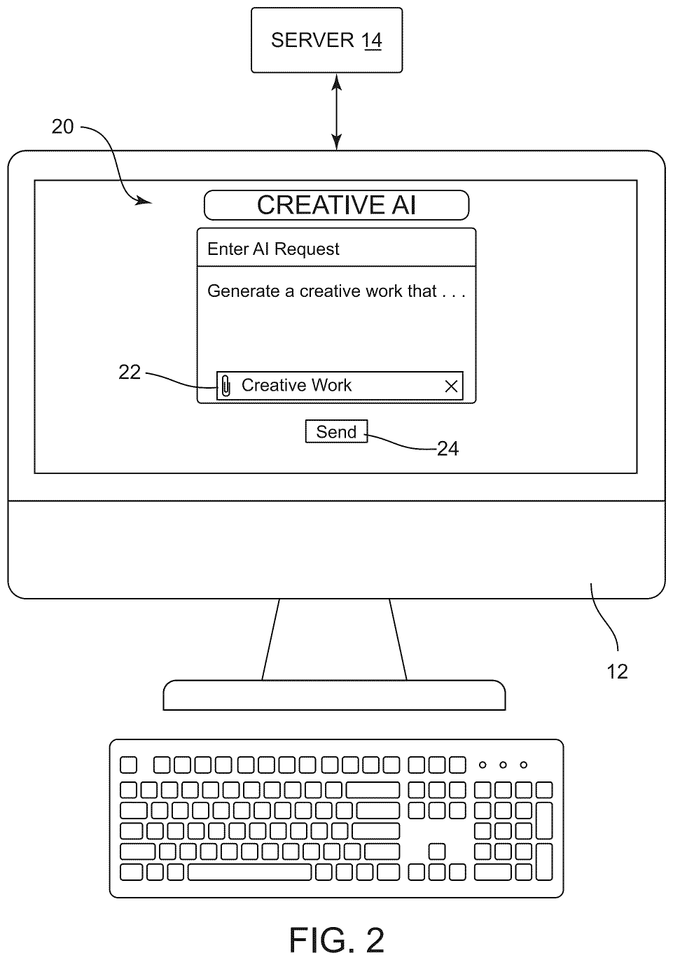

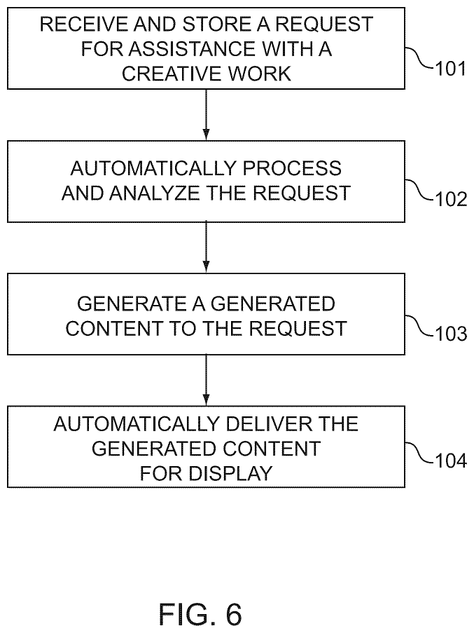

Referring additionally to FIGS. 2 and 6, the creator computing device 12 may be coupled to the server 14, and the server 14 may be programmed to receive and store a request for assistance with a creative work from the creator computing device 12, as shown in FIG. 2 (Step 101); automatically process and analyze the request for assistance with the creative work (Step 102); generate a generated content to the request for assistance with the creative work (Step 103); and automatically deliver the generated content for display on the creator computing device 12 (Step 104). The creative work may include computer code, written works, music works, artistic works and the like, thereby resulting in the generated content including computer code, written works, music works, artistic works and the like.

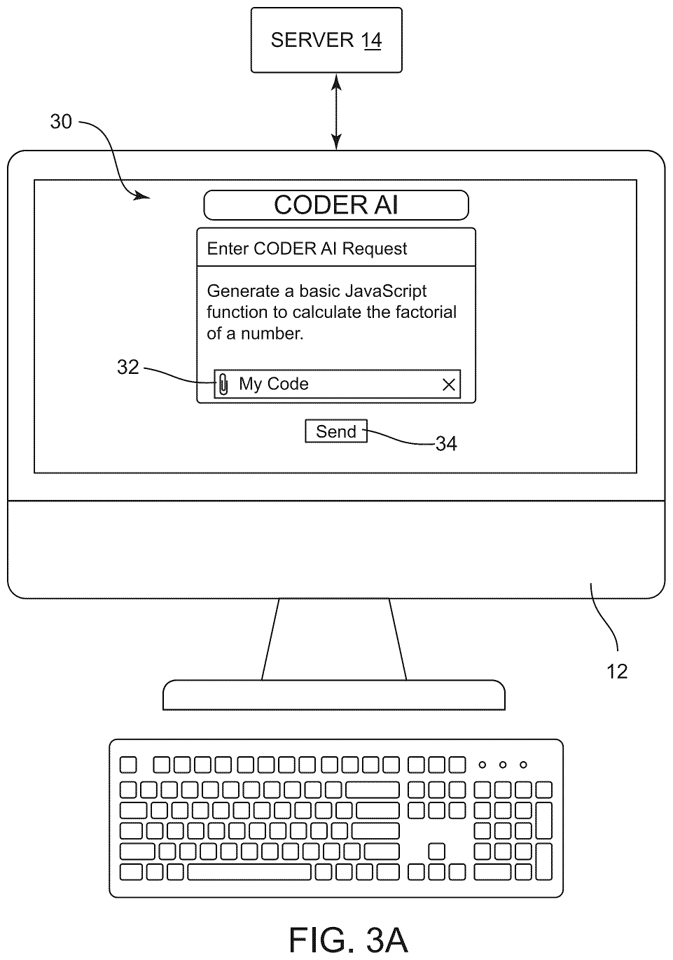

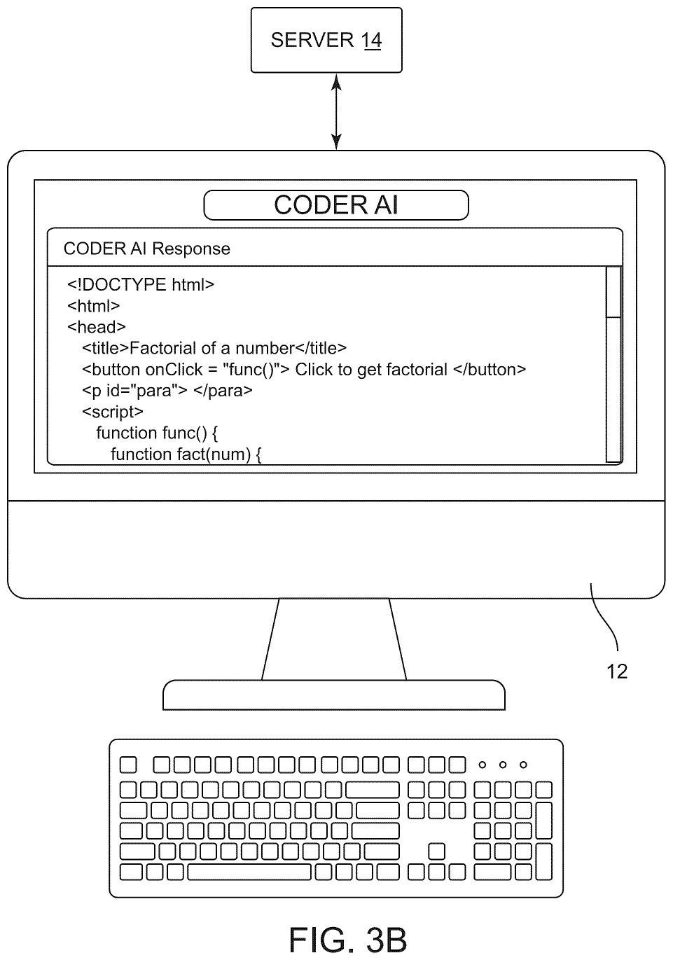

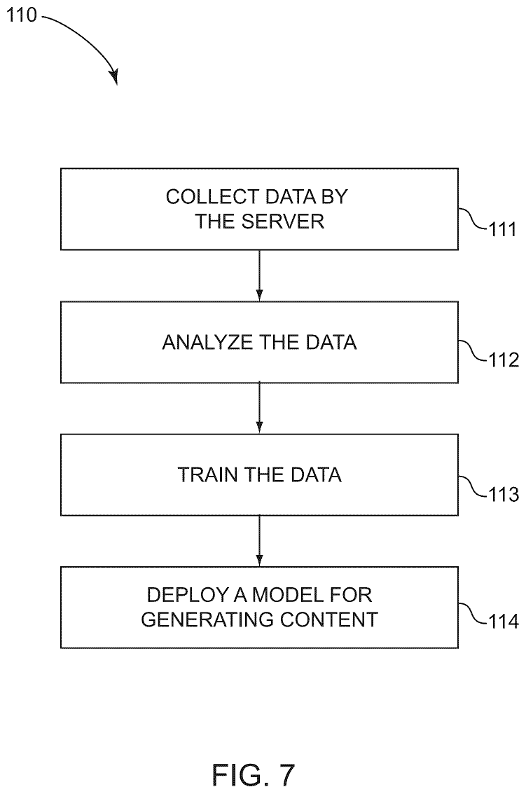

FIG. 2 depicts a creator computing device 12 displaying a creative work request for assistance with a creative work. The creator computing device 12 may include a user interface 20 that includes a request box or interface wherein the creator operating the creator computing device 12 can enter a request. As depicted in FIG. 3A, the creator may upload a sample file 22 containing a portion of a creative work created by the creator. The creator may then upload a portion of the creative work for which the creator wishes to receive assistance in completing or as a sample to refer to for the creative work request being sent. The creator may then select send for artificial intelligent suggestion, such as selecting “Send” button 24. By selecting the “Send” button 24, the sample file 22 and request may be sent to the server 14 operating the artificial intelligence software program. The AI software operates to analyze the portion of the creative work sent by the creator. The AI software may then generate generated content and send the same for display on the creator computing device 12 (not shown). It will be understood that the AI software operates to analyze the sample of creative work submitted. In some embodiments, the AI software may require a larger portion of the creative work in order to analyze and prepare a suggestion. For example, referring further to FIG. 7, a method 110 of developing a model for generating creative content (a machine learning method/algorithm) may include collecting data by the server (Step 111), such as by sending one or more samples of the creator's creative work to the server 14; analyze the data (Step 112); train the data (Step 113); and deploy a model for generating creative content (Step 114). In at least this way, the AI software may include programming for determining style, tone and the like of the sample of the creative work of the creator and then present a suggestion within the same style, tone and the like. In other embodiments, the AI software may only need a small portion or even just an entered request in order to prepare a suggestion. Again, the sample file 22 of the creative work may include computer code, written works, music works, artistic works and the like, thereby resulting in the generated content including computer code, written works, music works, artistic works and the like.

Referring to the drawings again, FIGS. 3A-5B depict various interfaces viewable with a creator computing device 12 that may be available by an embodiment of the AI creative work contribution system 10.

FIG. 3A depicts a creator computing device 12 displaying a creative work request for assistance with a computer code. The creator computing device 12 may include a user interface 30 that includes a request box or interface wherein the creator operating the creator computing device 12 can enter a request. As depicted in FIG. 3A, the creator may upload a sample file 32 containing a portion of computer code written by the creator. The creator may then upload a portion of the computer code for which the creator wishes to receive assistance in completing or as a sample to refer to for the coding request being sent. The creator may then select send for artificial intelligent suggestion, such as selecting “Send” button 34. By selecting the “Send” button 24, the sample file 32 and request may be sent to the server 14 operating the artificial intelligence software program. The AI software operates to analyze the portion of the computer code sent by the creator. The AI software may then generate a suggested computer code and send the same for display on the creator computing device 12 as shown in FIG. 3B. It will be understood that the AI software operates to analyze the sample of computer code submitted. In some embodiments, the AI software may require a larger portion of the computer code in order to analyze and prepare a suggestion. The AI software may include programming for determining style the computer code of the creator and then present a suggestion within the same style. In other embodiments, the AI software may only need a small portion or even just an entered request in order to prepare a suggestion. Additionally, the generated content may be stored and aggregated on the server corresponding to the creative work request.

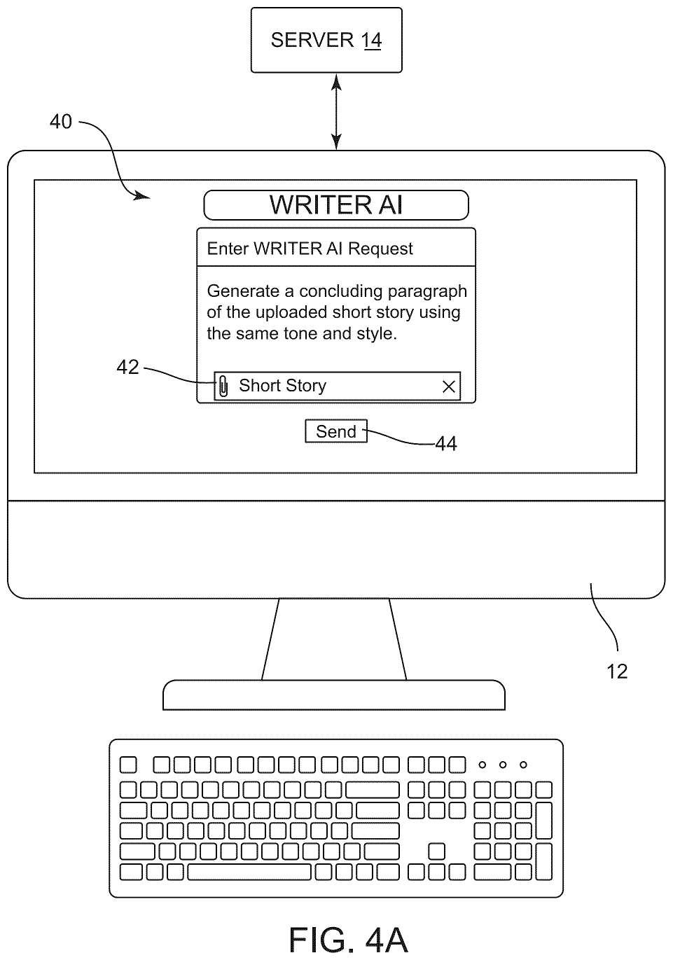

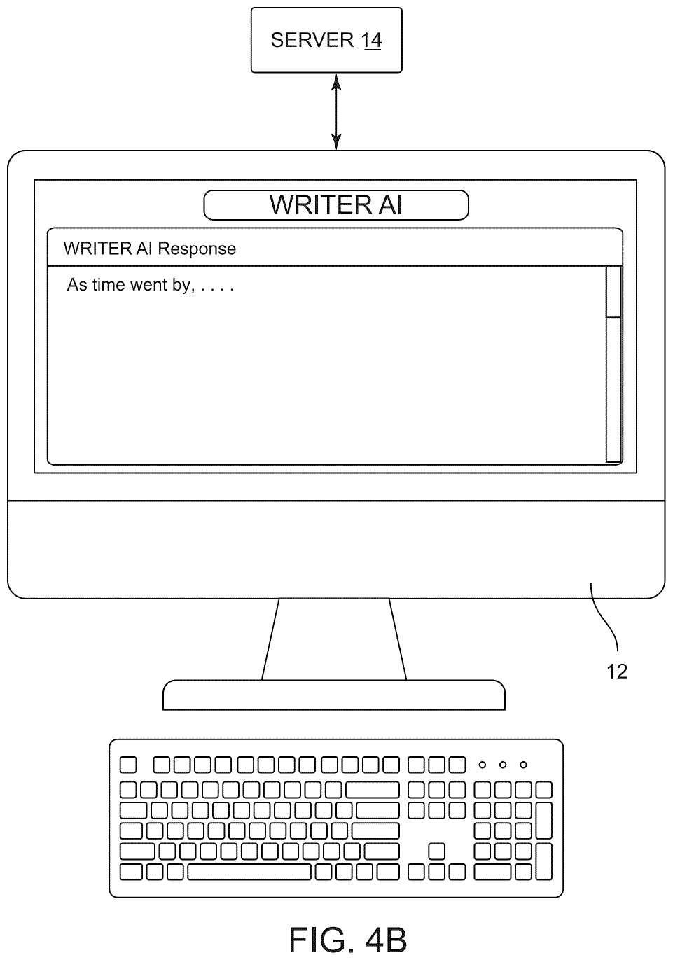

FIG. 4A depicts a creator computing device 12 requesting help with a written work, such as a short story. The creator computing device 12 may include a user interface 40 that includes a request box or interface wherein the creator operating the creator computing device 12 can enter a request. As depicted in FIG. 4A, the creator may upload a sample file 42 containing a portion of the written work by the creator. The creator may then upload a portion of the written work for which the creator wishes to receive assistance in completing or as a sample to refer to for the request being sent. The creator may then select send for artificial intelligent suggestion, such as selecting “Send” button 44. By selecting the “Send” button 44, the sample file 42 and request may be sent to the server 14 operating the artificial intelligence software program. The AI software operates to analyze the portion of the written work sent by the creator. The AI software may then generate a suggested written work and send the same for display on the creator computing device 12 as shown in FIG. 4B. It will be understood that the AI software operates to analyze the sample of written work submitted. In some embodiments, the AI software may require a larger portion of the written work or additional written works in order to analyze and prepare a suggestion. The AI software may include programming for determining style, tone and the like of the written work of the creator and then present a suggestion within the same style, tone and the like. In other embodiments, the AI software may only need a small portion or even just an entered request in order to prepare a suggestion. Additionally, the generated content may be stored and aggregated on the server corresponding to the creative work request. Further, while it is shown that the written work is a short story, the invention is not limited to short stories, but rather may include any type written work such as books, poems, short stories, manuals, plays, screen plays, manuscripts, articles, emails, essays, outlines, scripts, social media posts, advertisements, blogs and so forth.

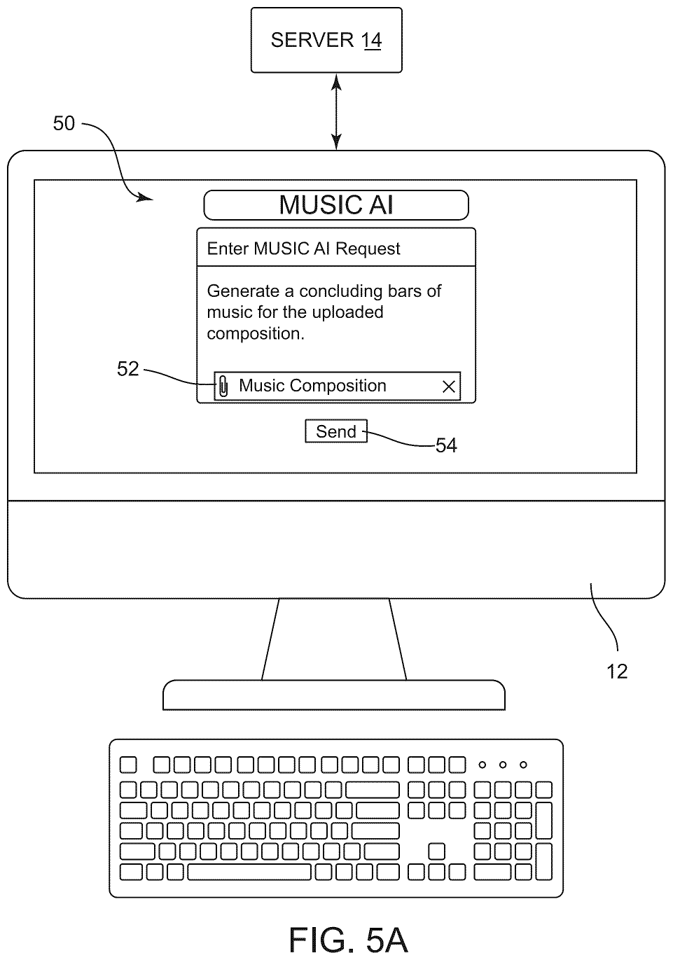

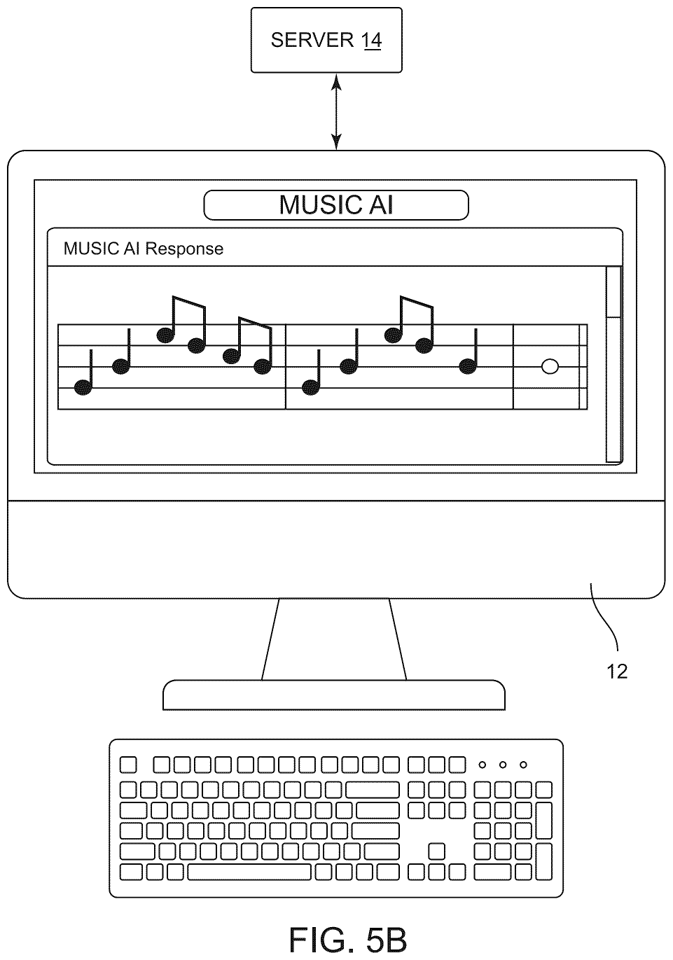

FIG. 5A depicts a creator computing device 12 requesting help with a music composition. The creator computing device 12 may include a user interface 50 that includes a request box or interface wherein the creator operating the creator computing device 12 can enter a request. As depicted in FIG. 5A, the creator may upload a sample file 52 containing a portion of the music composition by the creator. The creator may then upload a portion of the music composition for which the creator wishes to receive assistance in completing or as a sample to refer to for the request being sent. The creator may then select send for artificial intelligent suggestion, such as selecting “Send” button 54. By selecting the “Send” button 54, the sample file 52 and request may be sent to the server 14 operating the artificial intelligence software program. The AI software operates to analyze the portion of the music composition sent by the creator. The AI software may then generate a suggested music composition and send the same for display on the creator computing device 12 as shown in FIG. 5B. It will be understood that the AI software operates to analyze the sample of music composition submitted. In some embodiments, the AI software may require a larger portion of the music composition or additional music composition in order to analyze and prepare a suggestion. The AI software may include programming for determining style, tone and the like of the music composition of the creator and then present a suggestion within the same style, tone and the like. In other embodiments, the AI software may only need a small portion or even just an entered request in order to prepare a suggestion. Additionally, the generated content may be stored and aggregated on the server corresponding to the creative work request.

Embodiments may be available on or through the internet, such as through domain names reserved and owned by Applicant that include aicollaborator.com, myaicoder.com, aicodermusic.com, mybloggerai.com, aicodecreater.com, aimycodes.com, myaigenerator.app, myaikeyword.com, aicodewriter.app, aicopyrighter.com, and myaicopyrighter.com.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. An AI creative work contribution system comprising:
a server having a memory storing artificial intelligence software; and
a creator computing device of a creator coupled to the server, wherein the server is programmed with the artificial intelligence software to:
receive and store a request for assistance with a creative work from the creator computing device;
automatically process and analyze the request for assistance with the creative work;
generate a generated content to the request for assistance with the creative work; and
automatically deliver the generated content for display on the creator computing device.

2. The system of claim 1, wherein the server is further programmed to analyze a portion of a creative work of the creator to determine a style of the creative work.

3. The system of claim 2, wherein the artificial intelligence software learns the style of the creative work through analysis of the portion of the creative work.

4. The system of claim 3, wherein the server is further programmed to analyze a portion of a creative work of the creator to determine a tone of the creative work.

5. The system of claim 4, wherein the artificial intelligence software learns the tone of the creative work through analysis of the portion of the creative work.

6. The system of claim 5, wherein the generated content is generated by the artificial intelligence software in a same style and tone as the style and tone of the creative work of the creator.

7. The system of claim 1, wherein the creative work is computer code and the generated content is suggested computer code.

8. The system of claim 1, wherein the creative work is a written work and the generated content is suggested written content.

9. The system of claim 1, wherein the creative work is a music composition and the generated content is suggested music composition.

10. An AI creative work contribution system comprising:
a server having a memory storing artificial intelligence software; and
a creator computing device of a creator coupled to the server, wherein the server is programmed with the artificial intelligence software to:
receive and store a request for assistance with a computer code from the creator computing device;
automatically process and analyze the request for assistance with the computer code;
generate a suggested computer code to the request for assistance with the computer code; and
automatically deliver the suggested computer code for display on the creator computing device.

11. The system of claim 10, wherein the server is further programmed to analyze a portion of computer code of the creator, wherein the artificial intelligence software learns the style of the code writing of the creator through the analysis of the portion of computer code of the creator.

12. The system of claim 4, wherein the suggested computer code is generated by the artificial intelligence software in a same style as the style of the code writing of the creator.
